(19) United States
(12) Patent Application Publication
(10) Pub. No.: US 2018/0164454 A1
(43) Pub. Date: Jun. 14, 2018

(54) DETERMINING RESIDUAL STATICS OF SURVEY RECEIVERS

(71) Applicant: SCHLUMBERGER TECHNOLOGY CORPORATION, Sugar Land, TX (US)

(72) Inventor: Ismael Adan VERA RODRIGUEZ, Cambridge (GB)

(21) Appl. No.: 15/577,250

(22) PCT Filed: May 24, 2016
(86) PCT No.: PCT/US2016/033849

§ 371 Date: Nov. 27, 2017

Related U.S. Application Data
(60) Provisional application No. 62/166,781, filed on May 27, 2015.

(51) Int. Cl. G01V 1/36; G01V 1/28

(52) U.S. Cl. CPC G01V 1/362; G01V 2210/32; G01V 2210/1234; G01V 1/288

(57) ABSTRACT

Observed data responsive to a seismic event in a target structure is received. Moment tensor inversion is applied on the observed data. Residual statics of survey receivers are determined based on the moment tensor inversion.

### CROSS-REFERENCE TO RELATED APPLICATION

The present document is based on and claims priority to U.S. Provisional Application Ser. No. 62/166,781, filed May 27, 2015, which is incorporated herein by reference in its entirety.

### BACKGROUND

Microseismic monitoring can be performed with respect to a subsurface structure. Microseismic monitoring includes observing events that can occur in the subsurface structure as a result of human activities or industrial processes, such as perforating operations (which involve activating perforating guns to produce perforations in a formation surrounding a wellbore), hydraulic fracturing operations (which involve applying increased fluid pressure in a wellbore to cause fractures to form in the formation surrounding the wellbore), mining, and so forth. Unlike traditional survey operations that employ an active energy source (or active energy sources), microseismic monitoring is a passive operation in which the seismic receivers listen for seismic energy that is already occurring in the subsurface structure.

### SUMMARY

In general, according to some implementations of the present disclosure, observed data responsive to a seismic event in a target structure is received. Moment tensor inversion is applied on the observed data. Residual statics of survey receivers are determined based on the moment tensor inversion, where the residual statics result from unaccounted velocity variations in a velocity model of the target structure.

Other or further features will become apparent from the following description, from the drawings, and from the claims

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of an example survey arrangement, according to some implementations of the present disclosure.

FIG. 2 is a flow diagram of a process for determining residual statics of survey receivers, according to some implementations of the present disclosure.

FIG. 3 is a flow diagram of a process for determining residual statics of survey receivers, according to some implementations of the present disclosure.

FIG. 4 is a graph plotting residual static correction values as a function of receiver numbers, as determined according to some implementations of the present disclosure.

FIG. 5 is a block diagram of a computer system that incorporates some implementations of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

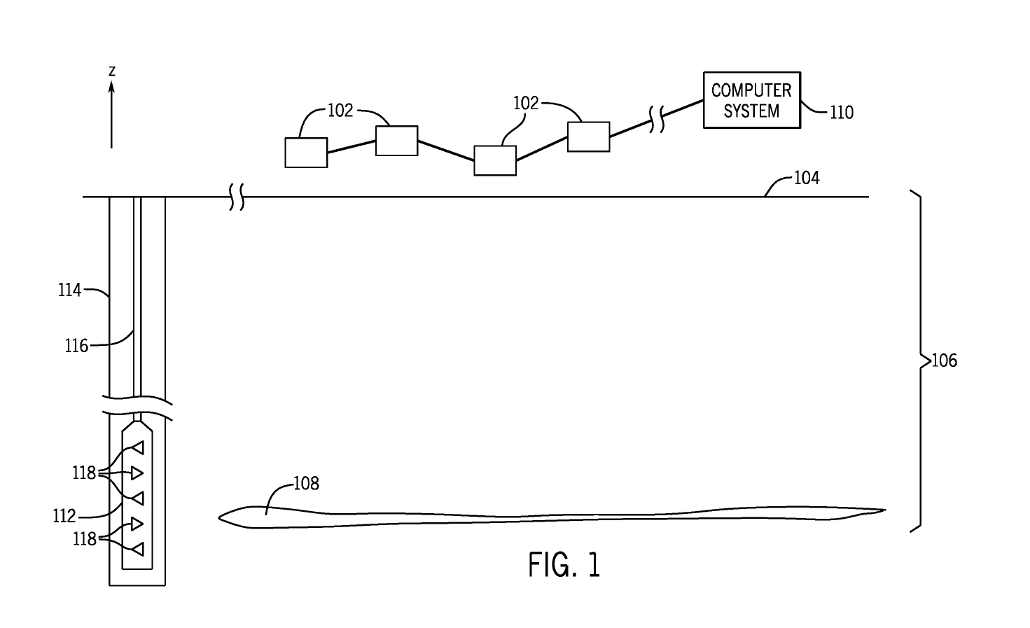

FIG. 1 is a schematic diagram of an example survey arrangement that includes multiple survey receivers 102 arranged on an earth surface 104. The survey receivers 102 can be seismic receivers, such as geophones, hydrophones, accelerometers, or other types of sensors that are able to detect particle motion. In other examples, other types of survey receivers can be employed.

The seismic receivers 102 can be used to perform active seismic surveying, in which case a seismic source (or multiple seismic sources) is (are) activated to produce seismic waves that are propagated into a subsurface structure 106 (e.g. earth formation) that can include one or more subsurface elements of interest (108). Examples of subsurface elements of interest include hydrocarbon bearing reservoirs, fresh water aquifers, gas injection zones, or other subsurface elements of interest. Different types of seismic sources can be employed. For example, a seismic source can include an air gun, a seismic vibrator, and so forth.

In other implementations, the seismic receivers 102 of FIG. 1 can be used for microseismic monitoring, which can refer to the observation of events that can occur in the subsurface structure 106 as a result of human activities or industrial processes, such as perforating operations (which involve activating perforating guns to produce perforations in a formation surrounding a wellbore), hydraulic fracturing operations (which involve applying increased fluid pressure in a wellbore to cause fractures to form in the formation surrounding the wellbore), mining, and so forth. Unlike traditional survey operations that employ an active energy source (or active energy sources), microseismic monitoring is a passive operation in which the seismic receivers 102 listen for seismic energy that is already occurring in the subsurface structure 106.

Although reference is made to performing operations with respect to a subsurface structure, techniques or mechanisms according to some implementations can also be applied with respect to other types of target physical structures, such as human tissue, plant tissue, animal tissue, a mechanical structure, a solid volume, a liquid volume, a gas volume, a plasma volume, and so forth.

The seismic receivers 102 are configured to detect wavefields arriving from the subsurface structure 106 that is underneath the earth surface 104. Wavefields propagate in the subsurface structure 106 as the result of either activated seismic source(s) or from other sources, such as perforating equipment, fracturing equipment, mining equipment, and so forth. The wavefields are detected by the seismic receivers 102. Measured data acquired by the seismic receivers 102 can be communicated to a computer system 110 for storage or for processing. Note that the computer system 110 can be located near the survey site, where the computer system 110 can be located, or at a remote location, such as at the facilities of a survey operator or some other entity.

In some cases, the topography of the earth surface 104 can introduce variations in the vertical heights of the seismic receivers 102. For example, an uneven earth surface 104 can cause different seismic receivers 102 to be at different heights (in the z direction as shown in FIG. 1) relative to a reference level, such as the sea level or some other specified level. When processing microseismic data using a surface array of seismic receivers, it can be assumed that the seismic receivers are located at the same height or reference level. The uneven topography of the earth surface 102 can introduce static time shifts into traces measured by the seismic receivers 102. Arrival times of wavefields recorded at the seismic receivers actually deployed at different heights can be different from the arrival times estimated when the receivers are assumed to be at the same reference level.

In other cases, the seismic receivers can already be deployed at the same level (for example, over a flat boundary) and so corrections for static shifts do not have to be performed.

A trace can refer to recorded data of the response of the subsurface structure 106 (or other target structure) to input energy (such as from one or more seismic sources or from another source) passing from the source(s) through subsurface layers to the seismic receiver(s). For exploration seismology applications (that include survey operations for acquiring data to identify and characterize subsurface elements of interest), the static time shifts introduced into the traces due to uneven topography of the earth surface 104 can be interpreted as undulations in the subsurface element 108 (where undulations may not be present, such as when the subsurface element 108 is flat). For microseismic monitoring, the static time shifts introduced into the traces can be interpreted as an incorrect location of a seismic source that produced wavefields.

The static time shifts introduced by topographic variations can be referred to as statics. More generally, a “static” can refer to any static shift caused by uneven heights of seismic receivers (or other types of survey receivers) relative to a reference level. If statics are not accounted for during processing of survey data acquired by the seismic receivers 102, then the geometry of a subsurface element (e.g. 108) may be distorted. In microseismic monitoring, if statics are not accounted for, seismic sources of interest may not be detected or may be incorrectly located.

A model of seismic velocities between the reference level and the actual heights of the seismic receivers can be used to estimate static corrections to account for the seismic receivers being at different heights from the reference level. The estimated static corrections are applied to measured traces.

After static corrections have been applied to the traces, smaller “residual statics” can still be present. These “residual statics” are the result of deviations of the model of seismic velocities in the subsurface structure 106 used to estimate static corrections from the actual velocities in the earth. The deviations of the model of seismic velocities can refer to deviations of the seismic velocities represented by the model from actual velocities in the subsurface structure 106.

If the seismic receivers are originally deployed at the same level and no static shifts have to be corrected, residual statics can still exist as the result of inaccuracies in the velocity model that is used to represent the seismic velocities of the medium where the seismic wavefields propagate before being recorded at the seismic receivers. In these circumstances, residual statics can also be referred to as station corrections.

In the present disclosure, although reference is made to addressing residual statics for land-based survey arrangements such as that depicted in FIG. 1, it is noted that residual statics can also be addressed for marine-based surveys, where a streamer of survey receivers can be towed by a marine vessel through a body of water, for acquiring survey data associated with a subsurface structure underneath a water bottom surface (e.g. the sea floor).

As further shown in FIG. 1, for purposes of determining residual statics of the seismic receivers 102, a perforating gun 112 deployed in a wellbore 114 can be used to provide perforation shots that can be used as reference events for estimating a model of residual statics of the survey receivers 102. The perforating gun 112 is lowered into the wellbore 114 on a carrier structure 116. The perforating gun 112 can be remotely activated to fire charges 118 that are in the perforating gun 112. A perforation shot introduced by activation of the perforating gun 112 produces seismic energy in a subsurface structure 106 that can propagate through the subsurface structure 106 for detection by the seismic receivers 102. In some arrangements, there can be multiple perforating guns 112, which can be activated at different times or concurrently to produce respective different perforation shots.

In other examples, other types of devices can be used to produce seismic energy for estimating residual statics according to some implementations of the present disclosure. Examples of such other devices include a device for producing a string shot (activation of an explosive in a pipe or tubing), a cross-well tomography downhole source (a downhole source in a first well that produces seismic energy for detection in a second well), fracturing equipment, and so forth.

Perforation shots are low magnitude events with wave arrivals (at the seismic receivers 102) that are rarely visible on individual records in surface microseismic monitoring. Estimation of residual statics using these calibration events with known position and origin time can be used to improve detection, location and moment tensor inversion of microseismic events produced during hydraulic fracturing or other subsurface operations. In other examples, instead of using perforation shots as events for estimating residual statics, the estimating of residual statics can be based on other types of seismic events, such as events corresponding to fracturing in which an elevated fluid pressure is applied in the wellbore 114 to extend fractures into a formation surrounding the wellbore 114.

In accordance with some implementations of the present disclosure, techniques are provided that use full waveform information and moment tensor inversion for estimating a model of residual statics of the seismic receivers 102. Moment tensor inversion is a seismic processing technique that analyzes a radiation pattern of seismic amplitudes at different locations to determine a fracture plane and displacement vector, and defines the mode of fracturing. A fracture plane can refer to a plane of a fracture in the subsurface structure 106, while a displacement vector can refer to relative displacement of two formerly adjacent points that have been separated by faulting. Displacement vector can be used to describe motion of a fault with respect to the distance and direction that one side of the fault has moved relative to the other.

Moment tensor inversion uses seismic moment tensor representations of subsurface events (such as events relating to perforation shots). The moment tensor representations can serve as a snapshot of the instantaneous deformation of the surrounding formation. Seismic moment tensors are able to describe whether a failure is shearing or tearing, if a change in volume has occurred (i.e. opening or closing fractures), or some combination of the foregoing.

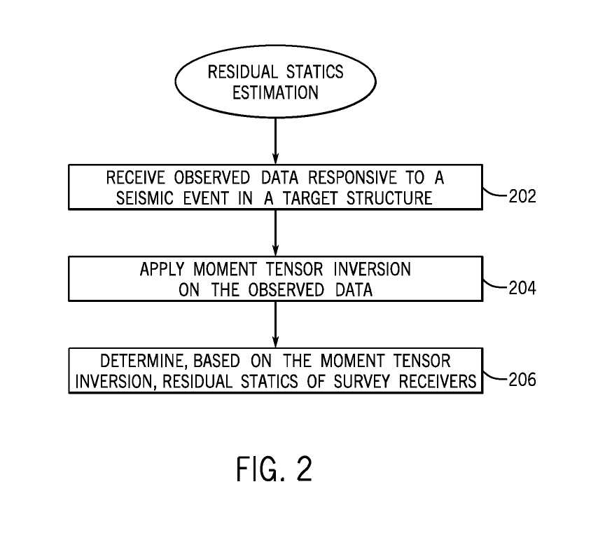

FIG. 2 is a flow diagram of a process of estimating residual statics according to some implementations. The process of FIG. 2 can be performed by the computer system 110, or by another computer system. The process receives (at 202) observed data (acquired by survey receivers, e.g. the seismic receivers 102) responsive to a seismic event, which can be produced by a perforating activity, other activity for producing seismic energy, fracturing activity, induced seismicity, and/or natural activity in a target structure (e.g. subsurface structure 106 in FIG. 1). Perforating activity can refer to one or more perforation shots due to activation of one or more perforating guns (e.g. 112). Fracturing activity can refer to a fracturing operation performed by fracturing equipment in a wellbore, such as the wellbore 114. Other activity can refer to activity provided by a string shot device, a cross-well tomography device, or other device. Induced seismicity can refer to seismic activity produced by man-made processes such as hydrocarbon extraction, CO2 sequestration, waste water injection, mining and so forth. Natural activity can refer to seismic events within the subsurface structure that take place without human intervention. The observed data as acquired by the seismic receivers 102 can include measurement data that is responsive to seismic events due to the perforating or fracturing activity in the target structure.

The process applies (at 204) moment tensor inversion on the observed data. The process then determines (at 206), based on the moment tensor inversion, residual statics of the survey receivers (e.g. seismic receivers 102).

The determined residual statics can be used to improve focusing for the imaging of microseismic sources, in some examples.

In accordance with some implementations, the residual statics of the survey receivers are determined on an individual survey receiver basis. In other words, the residual static for a first survey receiver is individually determined, followed by determining the residual static of a second survey receiver, and so forth.

More specifically, according to further implementations, residual statics are estimated on a receiver-by-receiver basis based on simultaneous optimization of the moment tensor inversion of a set of perforation records (containing observed data acquired by the survey receivers 102 in response to perforation shots or other seismic events).

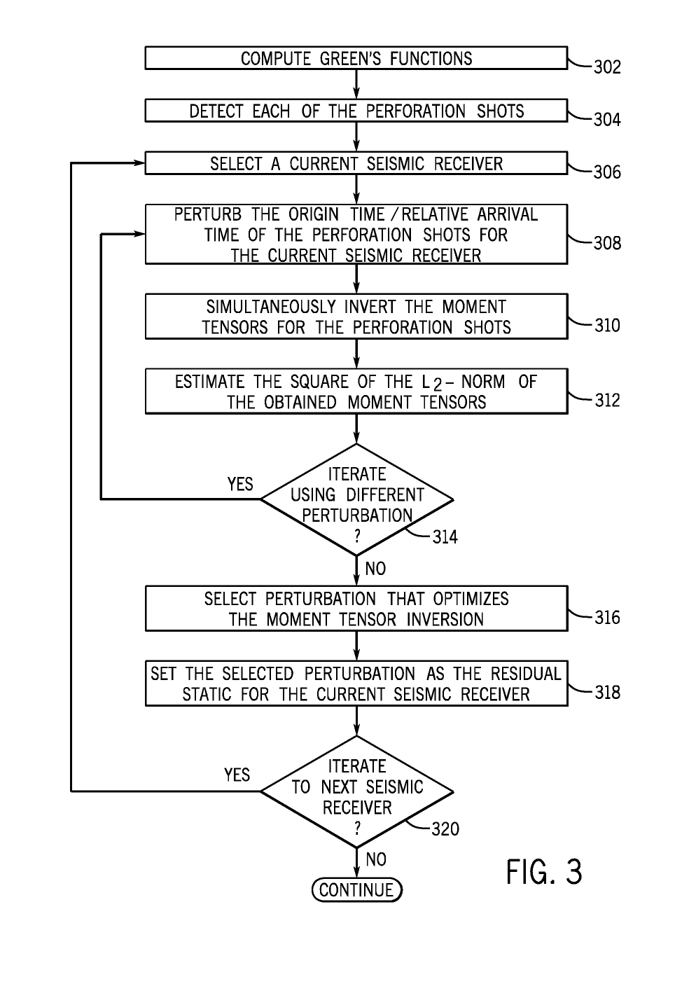

FIG. 3 is a flow diagram of a residual statics estimation process according to further implementations. The process can be performed by the computer system 110 of FIG. 1, or by another computer system. The process of FIG. 3 is an iterative process that includes multiple iterations for corresponding seismic receivers (one iteration of the process per seismic receiver). The process computes (at 302) full waveform elastodynamic Green's functions computed with a finite difference method or any other waveform modeling technique (e.g. ray tracing, etc.), for each available perforation shot of a current iteration. A Green's function can refer to an impulse response of an inhomogeneous differential equation defined on a domain, with specified initial conditions or boundary conditions. The Green's functions can be band-limited via convolution with an assumed source time function modeled with a Hanning window, in some examples. The Green's functions can represent the propagation of waves between locations of the perforation shots and the seismic receivers.

The process detects (at 304) each of the perforation shots to determine the origin time of the perforation shots and/or the relative arrival time of the seismic wavefields, produced by the perforation shots, in each seismic receiver. The process then selects (at 306) a current seismic receiver (receiver j in current iteration j) to estimate residual statics of the current seismic receiver.

The process perturbs (at 308) the origin time/relative arrival time of the perforation shots in the traces pertaining to the current seismic receiver. Perturbing the origin time/relative arrival time of the perforation shots in the traces includes time shifting the origin time/relative arrival time of the perforation shots by a specified time delay.

The process then simultaneously inverts (at 310) the moment tensors for the perforation shots using the traces from the seismic receivers that are being investigated, including the current seismic receiver that has been perturbed.

In some implementations, when individual waveform arrivals are modeled, such as with ray tracing, the residual statics can be estimated for individual arrivals. For example, the workflow from 306 to 320 in FIG. 3 can be performed by perturbing only the direct P-wave arrival times to estimate direct P-wave residual statics. Then, the same workflow can be repeated perturbing direct S-wave arrival times to estimate direct S-wave residual statics and so forth.

The perturbations in the origin time/relative arrival time can be applied to the observed traces or to the Green's functions. When individual arrivals are being investigated, the perturbations are applied to the Green's functions.

In some implementations, amplitude and polarity variations across an array of seismic receivers as a result of a change in a source mechanism can be accounted for in the moment tensor inversion. Wave arrivals do not have to be identified in individual traces; rather, techniques according to the present disclosure can rely on the redundancy provided by a large number of seismic receivers in the array and the simultaneous inversion of multiple perforation shots.

The process estimates (at 312) the square of the I₂-norm of the obtained moment tensors. In other examples, other norms or operators can be used. Next, the process changes (at 314) the perturbation in the current seismic receiver's traces, and re-iterates the moment tensor inversion and estimation of the square of the I₂-norm (tasks 310 and 312).

After exploring several perturbations around the estimated origin time/relative arrival time, the perturbation that optimizes the moment tensor inversion (i.e. is associated with the maximum I₂-norm of the obtained moment tensor from among the I₂-norm values computed for the different perturbations) is selected (at 316). If other norms or operators are used, then the perturbation selected can be the one associated with a minimum value or an inflection point. The selected perturbation is then set (at 318) as the static residual for the current seismic receiver.

The process then iterates (at 320) to the next current seismic receiver for investigation, and re-iterates tasks 308-318 to determine the residual static for the next current seismic receiver.

The process of FIG. 3 completes once each of the seismic receivers has been considered.

The residual statics obtained using the process of FIG. 3 are estimated in sequence (one seismic receiver at a time), to produce a model (or other representation) of the residual statics. The process of FIG. 3 can be performed for a given order of the seismic receivers, where the ordering can be according to a specified ordering criterion. Note that residual statics already estimated can be incorporated for the calculations of residual statics of subsequent seismic receivers.

Some of the calculations performed in the process of FIG. 3 employ a velocity model of the subsurface structure 106, where a velocity model includes velocities at different locations in the subsurface structure 106. The velocity model used for the calculations can be constructed with well logs collected by a well logging tool in a wellbore, such as the wellbore 114 of FIG. 1 or another wellbore. In other examples, a vertical seismic profile and/or a check shot can be used to construct a velocity model. Other methodologies such as seismic tomography, velocity analysis in reflection seismology, and/or direct measurements can also be used to construct a velocity model. The velocity model can be further calibrated with the observations of seismic events with known location (such as perforations, string shots, downhole sources, natural events, induced events, etc.) in a downhole monitoring array (that includes receivers deployed downhole in the wellbore) and/or a surface receiver array, and/or the same seismic receivers for which residual statics will be estimated.

In some implementations, the well logs (e.g. the vertical seismic profile and/or the check shot data) collected by the well logging tool in the wellbore can be used to construct an initial velocity model. Other velocity models derived from, for example, velocity analysis in reflection seismology, can also be used as initial velocity models. Then, direct P wave (compressional wave), Sv wave (shear wave polarized in the vertical direction), and Sh wave (shear wave polarized in the horizontal direction) arrivals are picked for the seismic events with known location using the downhole and/or surface monitoring records. These arrivals can serve as input to invert for the parameters of a calibrated velocity model, which can be anisotropic. A geological interpretation that can include the analysis of the correlation between well logs from different wells and geological horizons can also be used to incorporate structural geological information into the velocity model, for example, dipping layers. After incorporation of the structural geological information, discrepancies between observed and theoretical arrival times can be minimized via an inversion technique that determines the parameters of an equivalent velocity model, which can be anisotropic. The determined parameters form an elastic model.

In implementations of surface microseismic monitoring, for the processing of the surface monitoring records (containing observed data acquired by the seismic receivers 102), the vertical coordinate of all receivers can be shifted to a common datum that corresponds to the average topographic elevation of the array of seismic receivers. Using the calibrated elastic model, full-waveform band-limited elastodynamic Green's functions can be calculated for each seismic event with known location with a finite differences method or any other waveform modeling methodology, for example, ray tracing (as computed at 302 in FIG. 3). The calibrated elastic model can also be used to estimate static corrections that compensate for the difference in height between the elevation of the receivers and the reference level. These static corrections can be applied over the band-limited Green's functions or over the measured traces.

According to some examples, the origin time/relative arrival times for each seismic event with known location can be estimated using a surface array of seismic receivers (as performed at 304 in the FIG. 3 process). A tentative origin time of a seismic event can be postulated. The tentative origin time (of the seismic event as detected by the multiple seismic receivers of the array) is moved along a time window and at every new time position a moment tensor inversion is performed. In some examples, the misfit between the observed data relating to the seismic event and a moment tensor inversion solution at the investigated time positions is determined. When the misfit is minimum, the moment tensor inversion is optimized and the corresponding time position is taken as the origin time of the seismic event. In some implementations, the I₂-norm of the moment tensor solution instead of the misfit can be used to perform the optimization of the moment tensor inversion. Other norms and operators can also be used to optimize the moment tensor inversion, where the optimization point can be a maximum, a minimum or an inflection point.

Optimization can be identified by inverting for the moment tensor of the seismic event with known location at different origin times, and selecting the origin time that optimizes the moment tensor inversion solution. The origin times for the seismic events estimated with the surface array can be compared to the origin times of the same seismic events estimated with a different methodology, for example, using a downhole array of seismic receivers. The difference in the estimated origin times from different methodologies are referred to as bulk statics. The bulk statics from the different seismic events with known location are averaged and the result applied to the band-limited Green's functions. The bulk statics can be attributed to synchronization differences between different acquisition systems, for example, the surface acquisition system and the downhole acquisition system.

Note that the moment tensor inversion performed for bulk static corrections (to determine the origin time of a seismic event with known location) is different from the moment tensor inversion performed (at 310) for estimating the residual statics. For the estimation of residual statics, the origin time of the microseismic event (perforation shot) is fixed and then individual traces (of respective individual seismic receivers) are moved in time before performing the moment tensor inversion. For example, to compute the residual static correction for trace 1 (acquired by seismic receiver 1), the origin time of the microseismic event is fixed, and the other traces acquired by the other seismic receivers are also fixed. Thus, just trace 1 is time shifted within a time window centered around the fixed origin time. For each time shift (perturbation at 308) of trace 1, the moment tensor inversion is performed (at 310) using all traces, and then the I₂-norm of the moment tensor inversion solutions is computed to find an optimization of the moment tensor inversion. The time delay that corresponds to the optimization of the moment tensor inversion is the residual static correction for trace 1. Once the residual static correction is determined for trace 1, then the FIG. 3 process can proceed to repeat the residual static estimation process for trace 2 and each subsequent trace.

Note that, for bulk static corrections as discussed above, just one seismic event with known location is considered at a time in the moment tensor inversion. This results in one bulk static correction estimated per seismic event. The bulk static is expected to be constant, generally speaking, during the entire survey; therefore each seismic event with known location should output approximately the same bulk static correction from the analysis. However, due to noise and other inaccuracies in the assumptions made for the moment tensor inversion, the same bulk static correction value may not be obtained across the seismic events. As a result, an aggregate (e.g. average) of the bulk static corrections across the seismic events can be computed.

In contrast, in some implementations, when computing a residual static correction for an individual seismic receiver, the moment tensor inversion applied uses all available seismic events with known location in the current iteration at a time. More specifically, in some implementations, the same trace is shifted in time for the multiple seismic event records, and the moment tensor inversion is performed simultaneously for the multiple seismic events.

In some implementations, the origin time of the seismic event with known location can be measured or estimated through a different methodology. Instead of the origin time, the time of optimum alignment between the observations and the estimated relative arrival times of the wavefields produced by the seismic event can also be used as the fixed time from which perturbations are applied to estimate residual statics. The optimum alignment between observations and estimated arrivals can be determined based on the optimization of an objective function such as the misfit.

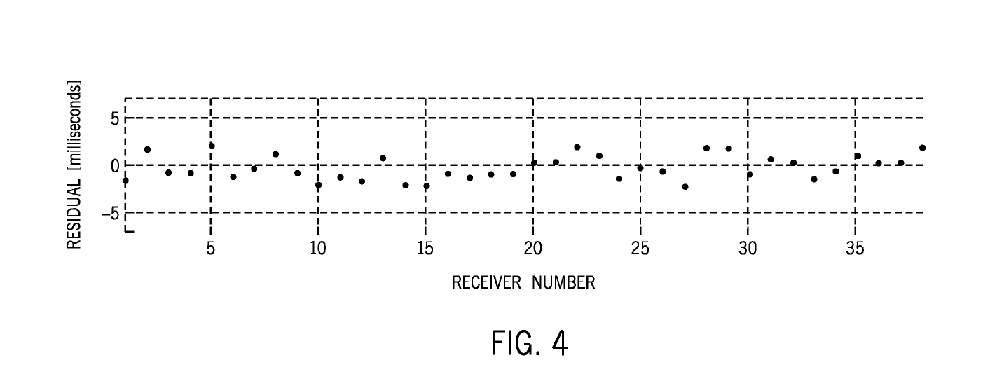

FIG. 4 is a graph that plots residual correction values (vertical axis) in terms of microseconds with respect to seismic receiver numbers (horizontal axis). Each seismic receiver number represents a respective seismic receiver in an array. A residual correction value represents the residual static for the respective seismic receiver. In FIG. 4, each seismic receiver number is associated with a dot that represents the respective residual correction value determined for the respective seismic receiver using techniques according to the present disclosure.

Incorporation of residual static corrections when processing observed survey data during a survey operation (e.g. microseismic monitoring or other survey operation) can produce improvements in the location of the seismic events with known location when estimated under the assumption that their location is unknown. Locating seismic events with known location under the assumption that their location is unknown is a method to validate the robustness of location methodologies. Survey data acquired by the survey operation can then be processed using a data processing technique that accounts for the determined residual statics. The data processing technique can include a migration of the observed data to produce an image of the location of seismic events, a full-waveform inversion (FWI) of the observed data to produce a model of the subsurface structure 106, and so forth.

The following provides an equation that represents a moment tensor inversion according to some implementations. The residual static correction for seismic receiver j of the array of seismic receivers (at the surface) can be estimated by optimizing the function {F(t=tᵢ)}ₖ:

{F(t=tᵢ)}ⱼ={∥mₜ₌ₜ_{ᵢ}∥₂²}ⱼ=∥(G^{H}G)⁻¹G^{H}u_{j,t=t}_{ᵢ}∥_{2′}²

tᵢ∈[t₀k,t₀+k].

where t₀ refers to the detected origin time (or the time of optimum alignment between observations and the estimated relative arrival times of the wavefields produced by the seismic event) of the seismic events with known location and k is a predefined tolerance value defining an interval to search for the optimum residual static. The notation G represents the band-limited Green's function as discussed above, and the notation u_{j,t=t}_{ᵢ} represents the trace of seismic receiver j as perturbed in time by tᵢ time samples simultaneously for the multiple seismic events (note that just the trace of seismic receiver j is perturbed—in other words, the traces of the other seismic receivers are not perturbed when optimizing the objective function for seismic receiver j). In addition, the notation mₜ₌ₜ_{ᵢ} in the equation above represents the moment tensor estimated with origin time (or time of optimum alignment) at tᵢ.

After applying the perturbation, the moment tensor inversion is performed for the multiple seismic receivers and the multiple seismic events with known location at the same time. The residual static for the receiver is then selected as the perturbation that optimizes the moment tensor inversion.

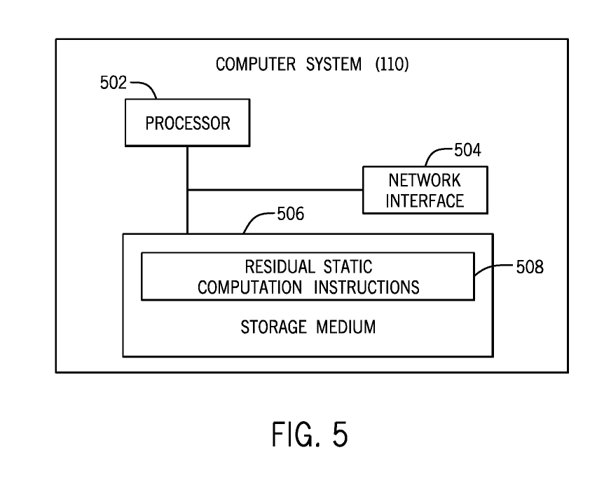

FIG. 5 is a block diagram of an example of the computer system 110, which can include a processor (or multiple processors) 502. A processor can include a microprocessor, microcontroller, a physical processor module or subsystem, a programmable integrated circuit, a programmable gate array, or another physical control or computing device.

The processor(s) 502 can be coupled to a network interface 504 (to allow the computer system 110 to communicate with another system over a network (wired or wireless), and a non-transitory machine-readable or computer-readable storage medium (or storage media) 506. Residual static computation instructions 508 are stored in the storage medium (storage media) 506, which can be executed on the processor(s) 502 to perform various tasks as discussed above (such as those depicted in FIG. 2 or 3 or discussed elsewhere in the present disclosure).

The storage medium (or storage media) 506 can be implemented as one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method comprising:
receiving, by a system, observed data responsive to a seismic event in a target structure;
applying, by the system, moment tensor inversion on the observed data; and
determining, by the system based on the moment tensor inversion, residual statics of survey receivers.

2. The method of claim 1, wherein the seismic event is caused by one or more of a perforating activity, fracturing activity in the target structure, a string shot, a downhole source, a natural seismic event, or an induced seismic event, and wherein a location of the seismic event is known.

3. The method of claim 1, wherein the survey receivers are arranged along a surface for surveying a target structure.

4. The method of claim 1, further comprising:
using the residual statics in processing survey data acquired by the survey receivers regarding the target structure.

5. The method of claim 1, wherein the residual statics of the survey receivers are determined on an individual survey receiver basis.

6. The method of claim 1, further comprising:
perturbing a trace of a given survey receiver of the survey receivers by plural time delays, wherein the determining comprises identifying a time delay of the plural time delays as the residual static for the given survey receiver.

7. The method of claim 6, wherein the identified time delay is the time delay that optimizes the moment tensor inversion relative to other time delays of the plural time delays.

8. The method of claim 7, wherein the moment tensor inversion is re-iterated for each of the plural time delays used to perturb the trace of the given survey receiver.

9. The method of claim 8, wherein perturbing the trace of the given survey receiver comprises perturbing an origin time or reference time of the seismic event in the trace by shifting the origin time or reference time by a specified time delay.

10. The method of claim 1, wherein the seismic event comprises a seismic event produced by activation of a perforating gun, a seismic event produced by activation of a string shot device, a seismic event produced by activation of a downhole source, a natural seismic event, or an induced seismic event.

11. The method of claim 10, wherein applying the moment tensor inversion comprises representing, using band-limited Green's functions, propagation of waves between locations of seismic events and the survey receivers.

12. A system comprising:
a storage medium to store observed data responsive to a seismic event and acquired by survey receivers along a surface; and
at least one processor configured to:
apply moment tensor inversion on the observed data; and
determine, based on the moment tensor inversion, residual statics of the survey receivers.

13. The system of claim 12, wherein the at least one processor is further configured to:
perturb a trace of a given survey receiver of the survey receivers by plural time delays, wherein the determining comprises identifying a time delay of the plural time delays as the residual static for the given survey receiver.

14. The system of claim 13, wherein the identified time delay is the time delay that optimizes the moment tensor inversion relative to other time delays of the plural time delays.

15. The system of claim 14, wherein the moment tensor inversion is re-iterated for each of the plural time delays used to perturb the trace of the given survey receiver.

16. The system of claim 15, wherein perturbing the trace of the given survey receiver comprises perturbing an origin time or reference time of the seismic event in the trace by shifting the origin time or reference time by a specified time delay.

17. The system of claim 12, wherein the seismic event is responsive to one or more of a perforation shot by a perforating gun, fracturing activity in the target structure, a string shot, a downhole source, a natural seismic event, or an induced seismic event, wherein a location of the seismic event is known.

18. An article comprising at least one non-transitory machine-readable storage medium storing instructions that upon execution cause a system to:
receive observed data acquired by seismic receivers and responsive to a seismic event in a target structure;
apply moment tensor inversion on the observed data; and
determine, based on the moment tensor inversion, residual statics of survey receivers.

19. The article of claim 18, wherein the determining of the residual statics comprises determining a residual static for each respective seismic receiver of the seismic receivers by time shifting an origin time of the seismic event in just a trace for the respective seismic receiver, and wherein the residual statics result from deviations of a model of seismic velocities in the target structure.
